(19) United States
(12) Patent Application Publication
(10) Pub. No.: US 2026/0054663 A1
(43) Pub. Date: Feb. 26, 2026

(54) LICENSE PLATE HOLDER

(71) Applicant: NIFCO AMERICA CORP., Canal Winchester, OH (US)

(72) Inventors: William Russell RHOADES, Columbus, OH (US); Benjamin D. HACK, Carroll, OH (US)

(21) Appl. No.: 19/302,086

(22) Filed: Aug. 18, 2025

Related U.S. Application Data
(60) Provisional application No. 63/685,706, filed on Aug. 22, 2024.

(51) Int. Cl. B60R 13/10

(52) U.S. Cl. CPC B60R 13/105

(57) ABSTRACT

A license plate holder includes a holder member for holding a license plate to a bumper of an automobile, and retaining members formed in the holder member. Each retaining member includes an opening configured to receive a bolt for attaching the license plate, a hollow cylindrical member projecting obliquely rearwardly from the holder member around the opening, a plurality of flexible thread catches formed around the opening to be spaced apart from each other and extending rearwardly from the opening toward a center of the cylindrical member, triangular ramps each being formed at an inner end of each of the thread catches and protruding into the center of the hollow cylindrical member, and a plurality of bolt guides formed inside the cylindrical member along a length thereof and equally spaced apart from each other.

### FIELD OF THE INVENTION

The present invention relates to a means or device of securing an automotive license plate to a license plate holder. More specifically, the present invention relates to a specially designed license plate holder that eliminates the need for metal nuts to assemble to the plastic holder for the license plate to be bolted.

### BACKGROUND OF THE INVENTION

At first, a conventional license plate and a holder are explained.

FIG. 1 shows an isometric front view of a base frame 30 with a front surface 32. The base frame 30 is a rectangular shape with two counter sunk mounting holes 31 located near the edges just above the center line in the horizontal direction and two insert windows 38 located near the top edge above the mounting holes 31. The insert windows 38 each have a retaining tab 39 on a side close to the edge of the base frame 30. A hole 40 is located in the center of the retaining tab 39.

FIG. 2 shows an isometric view of a nut insert 33. The nut insert 33 is made of bend metal that is formed into a U-shape that makes a retaining slot 34 that is open on one end. The front side of the U-shape has a hole 41 and the bottom side has a threaded shaft 35 in line with hole 41.

FIG. 3 shows an exploded isometric view of a license plate holder 36 being assembled. The nut inserts 33 are placed into the insert windows 38 of the base frame 30 with open end of the retaining slot 34 facing the retaining tab 39. Once the nut insert 33 is in the insert window 38, the nut insert 33 is pushed onto the retaining tab 39 until the hole 41 in the nut insert 33 is aligned with the hole 40 in the frame base 30.

FIG. 4 shows an isometric view showing an installation of the license plate holder 36 to a vehicles bumper 14. The mounting holes 31 in the license plate holder 36 are aligned with holes in the vehicles bumper 14, then mounting screws 13 are installed in the mounting holes 31 with a screwdriver 42 to secure the license plate holder 36 to the bumper 14.

FIG. 5 and FIG. 6 show an isometric front and rear view of a license plate 17. The license plate 17 has a rectangular shape with four bolt holes 25. Two bolt holes 25 are located along the top edge and two bolt holes 25 along the bottom edge.

FIG. 7 shows a bolt 16 to be used in installing the license plate 17 to the license plate holder 36.

FIG. 8 shows an isometric front view of a license plate 17 and an installed license plate holder 36. The top two bolt holes 25 in the license plate 17 are aligned with the holes 41 in the nut insert 33, then bolts 16 as shown in FIG. 7 are placed in the bolt holes 25 of the license plate 17 and the screwdriver 42 is used to thread the bolts 16 into the threaded shafts 35 of the nut insert 33. The license plate 17 is secured to the license plate holder 36 as the flat surface 19 of the bolt 16 is pushed against a front surface 26 of the license plate 17 until the back surface 27 of the license plate 17 is tight to the front surface of the base frame 30.

To remove the license plate 17 from the license plate holder 36, the screwdriver 42 is used to unthread the bolt 16 from the threaded shaft 35 of the nut insert 33.

As explained above, in installing the license plate to the holder, the meal bolts and metal nuts are used. Thus, in installing the automotive license plate to the holder, a screwdriver, wrench or socket is required to install mounting bolts.

However, the metal bolts or metal nuts tend to rust over time causing an issue when the license plate is removed from the license plate holder. Also, in manufacturing the current license plate holder, it requires an assembly process that uses a person to assemble the metal nut inserting to the plastic holder for the bolts to be threaded into.

It is therefore an object of the present invention to provide a new and improved license plate holder that has all the advantages over the prior art

Another object of the present invention is to provide a license plate holder that integrates a plastic retaining member into a molded plastic license plate holder, wherein the bolts would be able to be pushed in the plastic retaining member without a hand tools to secure the license plate to the holder, and the bolts can be removed with basic hand tools when the license plate needs to be removed.

A further object of the present invention is to eliminate the need for inserting metal nut components into the license plate holder in an assembly. Removing this process would decrease the manufacturing cost of such a license plate holder.

### SUMMARY OF THE INVENTION

In view of the foregoing disadvantages inherent in the known types of metal nut inserts used on a license plate holder now present in the prior art, the present invention provides a new type of license plate holder that can be utilized for providing convenience for the user when installing an automotive license plate to a license plate holder.

In a first aspect of the invention, a license plate holder of the invention comprises a holder member for holding a license plate, the holder member being configured to be attached to a bumper of an automobile; and retaining members formed in the holder member.

Each retaining member includes an opening configured to receive a bolt for attaching the license plate, a hollow cylindrical member projecting rearwardly from the holder member around the opening, a plurality of flexible thread catches formed around the opening to be spaced apart from each other and extending obliquely rearwardly from the opening toward a center of the cylindrical member, triangular ramps each being formed at an inner end of each of the thread catches and protruding into the center of the hollow cylindrical member, and a plurality of bolt guides formed inside the cylindrical member along a length thereof and equally spaced apart from each other so that when the bolt is configured to be inserted into the retaining member to attach the license plate, the bolt passes through and engages the triangular ramps.

In another aspect of the invention, the license plate holder according to the first aspect further comprises tension tabs formed in the holder member each protruding outward at an angle from a front surface of the holder member where the license plate is attached to push the license plate from the license holder when installed, each tension tab being angled to push a front side thereof.

In a further aspect of the invention, the license plate holder according to the first aspect, the retaining member further includes ribs spaced apart from each other outside the cylindrical member to extend along an entire length thereof.

### BRIEF DESCRIPTION OF THE DRAWINGS

Although the characteristic features of this invention will be particularly pointed out in the claims, the invention may be better understood after a review of the following description, taken in connection with the accompanying drawings wherein like numeral annotations are provided throughout.

FIG. 1 shows an isometric front view of a base frame of prior art.

FIG. 2 shows an isometric view of a nut insert.

FIG. 3 shows an isometric view of a license plate holder of prior art having nuts inserts installed.

FIG. 4 shows an isometric view of the license plate holder of prior art being installed on a vehicle.

FIG. 5 shows an isometric front view of the license plate.

FIG. 6 shows an isometric rear view of the license plate.

FIG. 7 shows an enlarged side view of a bolt.

FIG. 8 shows an isometric top view of the license plate of prior art being install on a license plate holder.

FIG. 9 shows an isometric front view of the license plate holder of the invention.

FIG. 10 shows an isometric rear view of the license plate holder.

FIG. 11 shows a detailed front view of the license plate holder.

FIG. 12 shows an enlarged isometric cross sectional view taken along line 12-12 in FIG. 9.

FIG. 13 shows an enlarged isometric rear detail view of the license plate holder.

FIG. 14 shows an enlarged cross sectional view taken along line 14-14 in FIG. 11.

FIG. 15 shows an enlarged isometric cross sectional view taken along line 15-15 in FIG. 9.

FIG. 16 shows an isometric view of the license plate holder being installed on a vehicle.

FIG. 17 shows an isometric view of the license plate being installed on a license plate holder.

FIG. 18 shows a top view of the license plate being install on a license plate holder.

FIG. 19 shows an enlarged cross sectional view taken along line 19-19 in FIG. 18.

FIG. 20 shows a top view of the license plate being installed on a license plate holder.

FIG. 21 shows an enlarged cross sectional view taken along line 21-21 in FIG. 20.

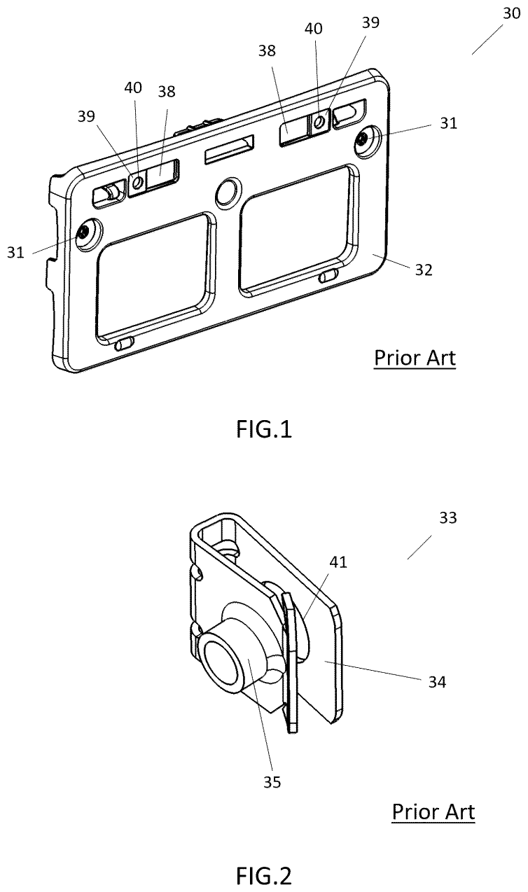

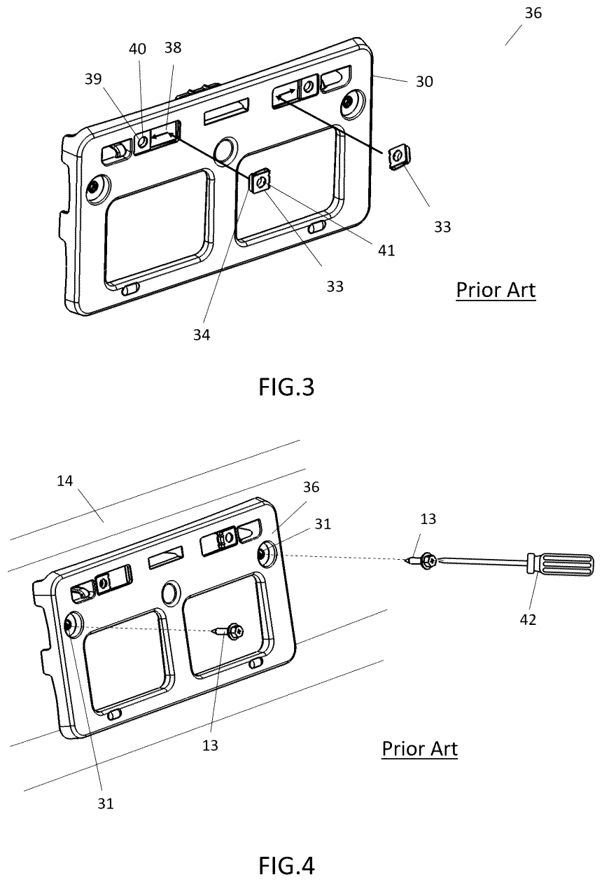

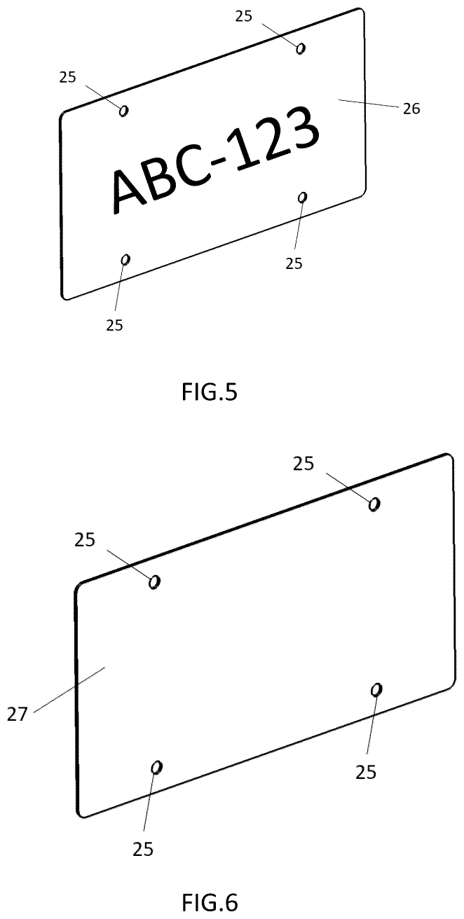

### DETAILED DESCRIPTION OF THE INVENTION

The following detailed description is exemplary in nature and is not intended to limit the application and uses. Furthermore, there is no intention to be bound by any theory presented by the followings.

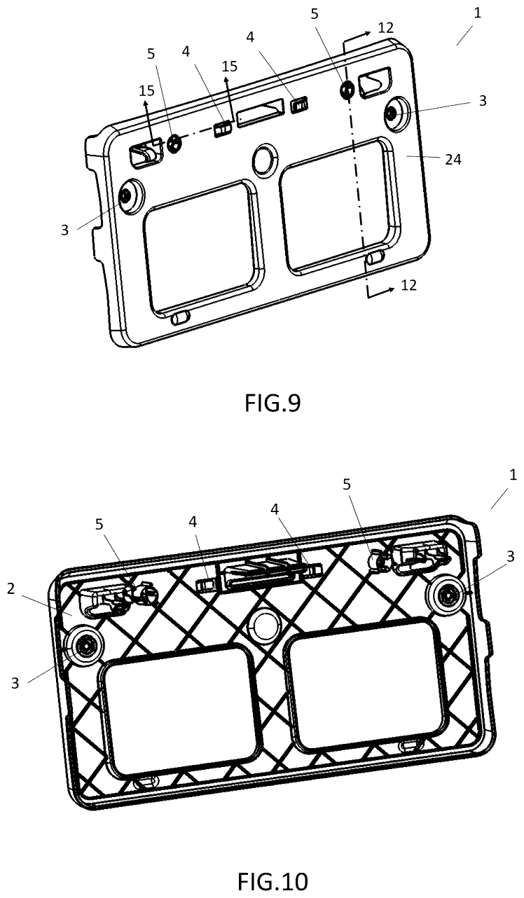

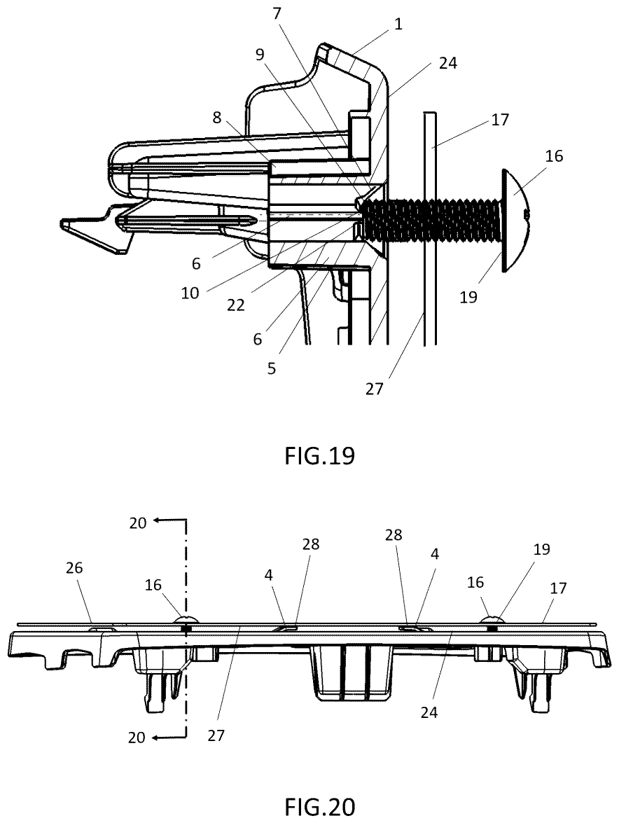

The present invention is shown in FIG. 9 to FIG. 21.

FIG. 9 through FIG. 15 show detailed views of a license plate holder 1 of the present invention. The license plate holder 1 has a rectangular shape with two counter sunk mounting holes 3 located near the far edges just above the center line in the horizontal direction, two push in nut features or retaining members 5 located along the top edge above the mounting holes 3 and two tension tabs 4 located in line between the two retaining members 5.

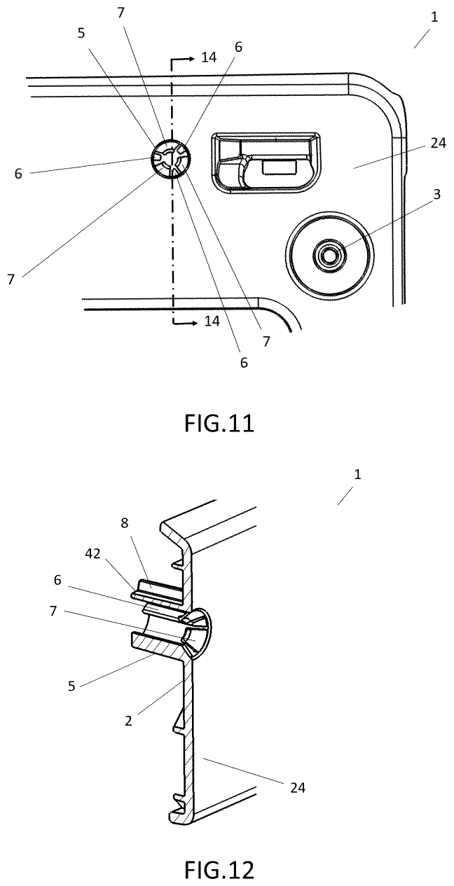

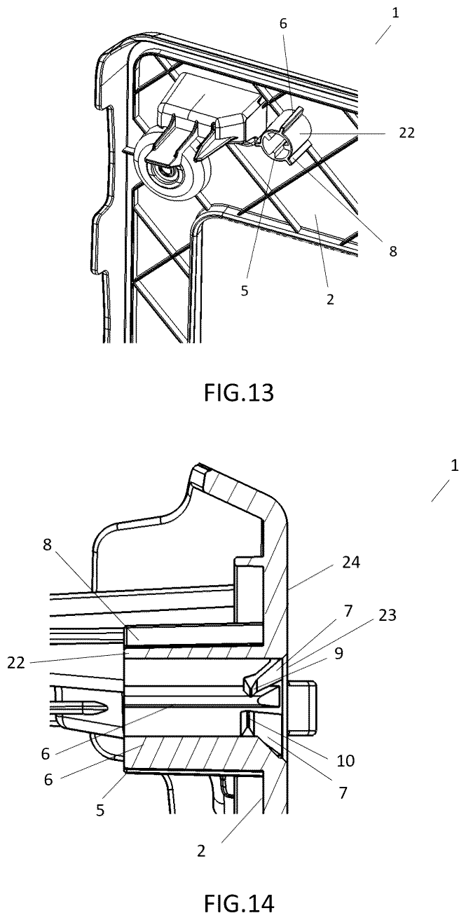

The retaining member 5 is a hollow cylindrical shape tube or cylindrical member 22 with a front opening 23 extruding from a back surface 2 of the license plate holder 1 that is open on a front surface 24 with three support ribs 8 equally spaced around the outside perimeter of the cylindrical member 22 along the length thereof (FIG. 13). Three equally spaced thread catches 7 (FIG. 11) are located at the end of the tube near the front surface 2 of the license plate holder 1 with a space between two of the thread catches 7. The thread catches 7 are triangular shaped thin tabs that protrude angularly downward towards the center of the cylindrical member 22 from the front surface 24 with a circular shaped opening being created in the middle where the three thread catches 7 come together.

A triangular shaped ramp 9 (FIG. 14) protrudes inward from the bottom edge of the thread catches 7 creating an engagement lip 10 on the innermost edge. Three bolt guides 6 are located in the spaces between the threaded catches 7 that run the length of the tube 22.

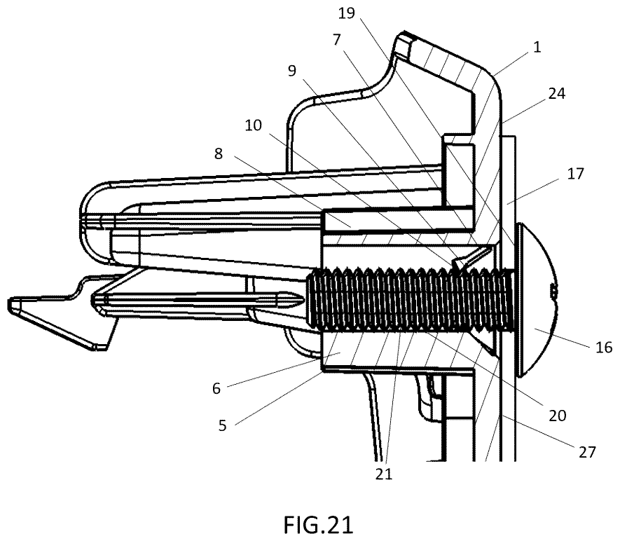

Namely, the bolt guides 6 run the length of the inside surface of the hollow cylindrical shape tube or cylindrical member 22. There are three separate bolt guides 6 each being located between two of the separate thread catches 7 with a space therebetween (FIG. 11). The bolt guides 6 and thread catches 7 are attached separately to the inside surface of the cylindrical member 22. The thread catches 7 hinge from the inside surface of the hollow cylindrical member 22 and the bolt guides 6 are stationary on the inside surface of the hollow cylindrical member 22 which is shown in FIG. 14 and FIG. 21 as the bolt 16 is inserted.

The three support ribs 8 that are disposed outside of the cylindrical member 22 including the bolt guides 6, and thread catches 7 are all part of the license plate holder 1 in FIGS. 12 and 21. The bolt guides 6, the thread catches 7, and the support ribs 8 are all integrated parts of the of the license plate holder 1 which is injection plastic that is molded as one part.

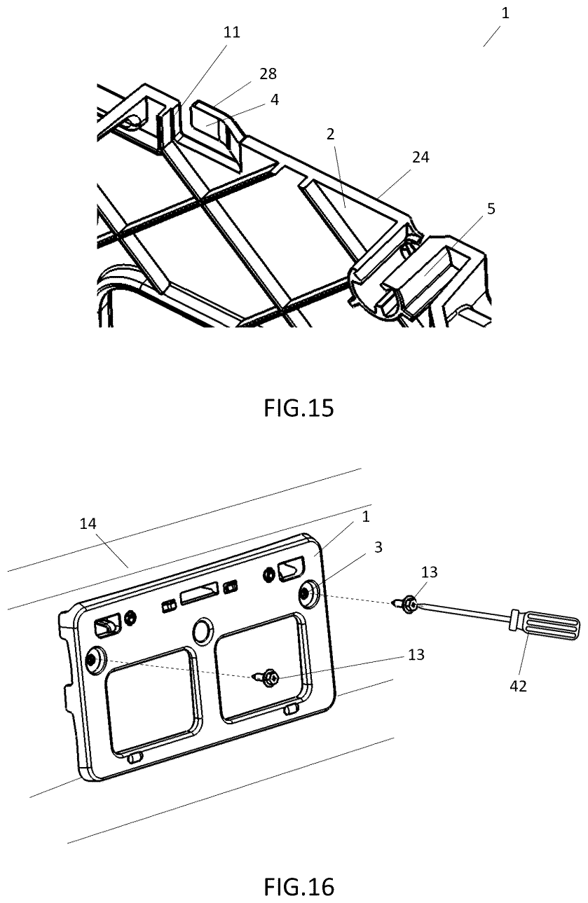

Tension tabs 4 (FIGS. 9 and 15) are located within U-shaped slots 11 in the front surface 24 of the license plate holder 1. The tension tab 4 has a rectangular shapes protruding out of the side of the slot 11 at an angle up and away front the front surface 24 of the license plate holder 1 with a flat rectangular shaped surface 28 protruding from the edge of the angled protrusion that is parallel to the front surface 24.

FIG. 16 shows an isometric view of a vehicle installation of the license plate holder 1 to a vehicles bumper 14. The mounting holes 3 in the license plate holder 1 are aligned with holes in the vehicles bumper 14, then mounting screws 13 are installed in the mounting holes 3 with a screwdriver 42 to secure the license plate holder 1 to the bumper 14.

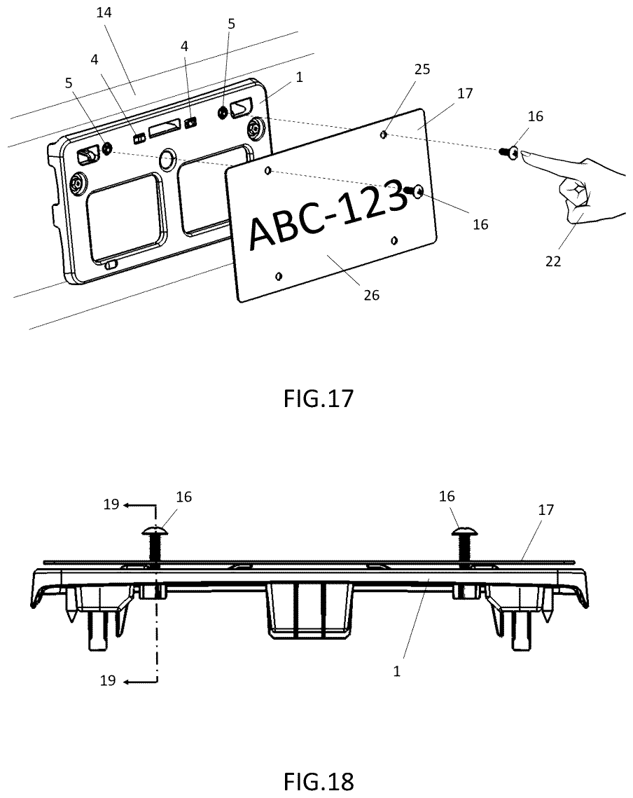

FIG. 17 through FIG. 21 show isometric front views showing an installation of a license plate to an installed license plate holder 12.

The top two bolt holes 25 in the license plate 17 are aligned with the centers of the retaining members 5 in the license plate holder 1, then bolts 16 are placed in the centers of the retaining members 5 of the license plate 1 and pushed in by hand 22. As the bolt 16 is pushed in, it is forced to maintain a central location within the retaining members 5 by the bolt guides 6 as the thread catches 7 are flexed outward away from the center by the bolt 16. The engagement lips 10 of the ramps 9 on the ends of the thread catches 7 ride up the crests 20 and drop down into the roots 21 of the threads 23 of the bolt 16 to retain the bolt 16 to the license plate holder 1 in one direction which only allows the bolt 16 to be pushed in and not pulled out.

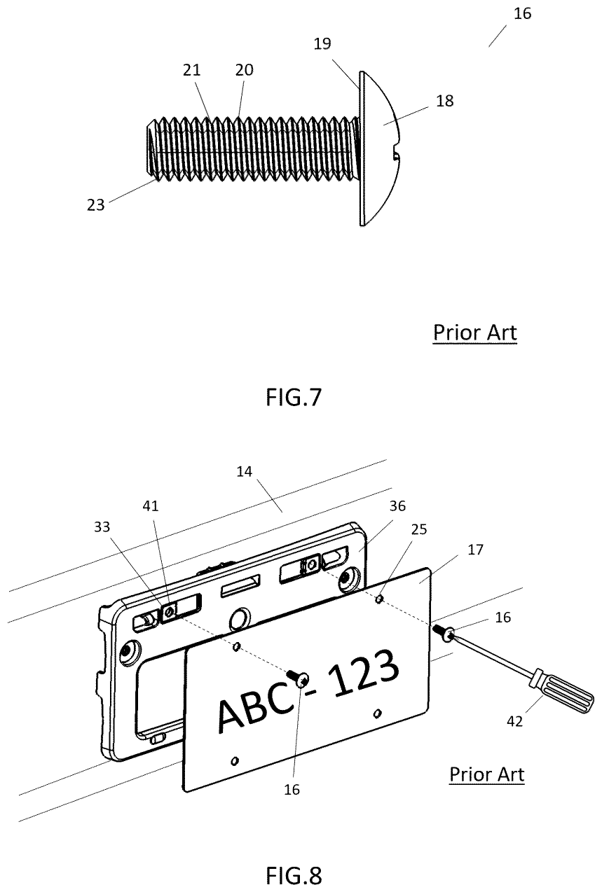

The flat surface 19 of the head 18 of the bolt 16 (FIG. 7) pushes the front surface 26 of the license plate 17 until the back surface 27 of the license plate 17 touches the front surface 28 of the tension tabs 4 which causes the tension tabs 4 to flex down towards the front surface 24 of the license plate holder 1. The tension tabs 4 will flex until the back surface 27 of the license plate 17 touches the front surface 24 of the license plate holder 1. The tension tabs 4 apply force to the back surface 27 of the license plate 17 which in turn applies force to the flat surface 19 of the head 18 of the bolt 16 keeping it from vibrating loose on a vehicle.

To remove the license plate 17 from the license plate holder 1, the screwdriver 42 (FIG. 16) may be used. Namely, the screwdriver 42 is placed to unthread the bolt 16 from the thread catches 7 of the retaining member 5 in the license plate holder 1, and the bolt 16 is pulled out.

In case another license plate is placed on the license plate holder 1, a bolts 16 are used to attach to the retaining members.

While the present invention has been explained with reference to the specific embodiment of the invention, the explanation is illustrative and the present invention is limited only by the appended claims.

What is claimed is:

1. A license plate holder, comprising:
a holder member for holding a license plate, the holder member being configured to be attached to a bumper of an automobile; and
retaining members formed in the holder member, each retaining member including an opening configured to receive a bolt for attaching the license plate, a hollow cylindrical member projecting rearwardly from the holder member around the opening, a plurality of flexible thread catches formed around the opening to be spaced apart from each other and extending obliquely rearwardly from the opening toward a center of the cylindrical member, triangular ramps each being formed at an inner end of each of the thread catches and protruding into the center of the hollow cylindrical member, and a plurality of bolt guides formed inside the cylindrical member along a length thereof and equally spaced apart from each other so that when the bolt is configured to be inserted into the retaining member to attach the license plate, the bolt passes through and engages the triangular ramps.

2. The license plate holder according to claim 1, further comprising tension tabs formed in the holder member each protruding outward at an angle from a front surface of the holder member where the license plate is attached to push the license plate from the license holder when installed, each tension tab being angled to push a front side thereof.

3. The license plate holder according to claim 1, wherein the retaining member further includes ribs spaced apart from each other outside the cylindrical member to extend along an entire length thereof.

4. The license plate holder according to claim 1, wherein the holder plate further includes mounting holes for mounting the holder member to a vehicle bumper, said mounting holes being located close to outer edges of the holder member.

5. The license plate holder according to claim 1, wherein each of the triangular ramps further includes an engagement lip at a tip thereof configured to engage threads of the bolt inserted into the retaining member.
